(19) United States
(12) Patent Application Publication
(10) Pub. No.: US 2023/0246954 A1
(43) Pub. Date: Aug. 3, 2023

(54) EDGE BASED ROUTING SOFTWARE INSTANCE, DEVICE AND METHOD

(71) Applicant: Booz Allen Hamilton Inc., McLean, VA (US)

(72) Inventors: Jeffrey Robert Palumbo, Colts Neck, NJ (US); Louis Edward Thiery, Washington, DC (US)

(73) Assignee: Booz Allen Hamilton Inc., McLean, VA (US)

(21) Appl. No.: 18/162,252

(22) Filed: Jan. 31, 2023

Related U.S. Application Data
(60) Provisional application No. 63/305,062, filed on Jan. 31, 2022.

(51) Int. Cl. H04L 45/302; H04L 45/24; H04L 45/44

(52) U.S. Cl. CPC H04L 45/3065; H04L 45/24; H04L 45/44

(57) ABSTRACT

An edge based routing (EBR) software instance configured on a device for a multi-transport network architecture is disclosed, the edge based routing device including an edge based routing core having a processor configured for providing service model based data services and utility functions; a client application programming interface configured for receiving producer application data and for outputting consumer application data; and a proxy application programming interface configured for establishing network layer path selection connectivity between producer applications and consumer applications as a function of network conditions and/or capabilities.

### CROSS-REFERENCE

This U.S. Non-Provisional application is related to and claims priority to U.S. Provisional Application No. 63/305,062, filed on Jan. 31, 2022, the entire contents of which are incorporated herein by reference.

### FIELD

An edge based routing (EBR) software instance configured as an EBR device for a multi-transport network architecture is disclosed, wherein edge based routing encompasses data convergence of a tactical data fabric with multi-level security for message and object-oriented data exchanges. A method is also disclosed for managing communication across multiple networks, between a producer application of a network and a consumer application of a network, using a network edge based routing (EBR) device.

### BACKGROUND INFORMATION

Digital transformation can provide a valuable opportunity for core mission functions to move away from manual processes and automate critical areas like Sensors, C2, and Fires & Effects. This can allow a commander's decision-making while shortening processing time on actionable information in an era of Joint All Domain Command and Control (JADC2). Modernization efforts address increasing interoperability, situational awareness, and lethality to take on Near-Peer adversaries and enable the joint force to converge effects from all domains.

Core to Joint All Domain Command and Control (JADC2) is Command, Control, Computers, Communications, Cyber, Intelligence, Surveillance, and Reconnaissance (C5ISR), and at the heart of the C5TSR mission is data. Data is the commodity that commanders need in order to take intelligent action. Data is also needed by soldiers of all echelons to shoot, move, and communicate effectively. Data is exploited through its dissemination and use for situation understanding.

In the digital battlespace, the explosion of data sources and software-driven capabilities now available—from direct human observations and automated sensors to legacy data now digitized for broader user—has resulted in a deeper reliance on data to make informed decisions. The pace at which software, configurations, and data connections need to be updated and deployed must be increased to match the evolving pace of battle.

EBR is a software service framework that can include middleware (e.g., an EBR core) and at least one Application Programming Interface (API) that operates to provide processor based client applications with a means to find and offer data across multi-transport, network architectures. EBR can serve as a core abstraction, alleviating applications of any burden of needing to be aware of available networks and their unique network capabilities. EBR can leverage available transports at each node to optionally perform, for example, service and/or sensor discovery, smart-routing, and efficient data dissemination between client applications and services.

Using network-aware path selection and link monitoring, EBR can persist data delivery while operating in dynamic topologies. In order to maximize a density of data delivered given network conditions (e.g., maximize data transmitted over a network path), EBR can use content-aware shaping rules to decrease traffic loading while increasing data density without needing to modify applications executing on EBR devices. The data shaping capability of the EBR device may be helpful for capacity-limited network architectures that do not readily or optimally support true end-to-end network-layer connectivity. The result is an increase in resilient data delivery to end users (e.g., a soldier of a tactical environment), which can lead to a greater trust in the network architecture.

The present disclosure addresses the problem of achieving an EBR device system which is agnostic to domains, platforms, and functional-mission lanes in the face of present day challenges presented by an ever evolving tactical environment. A viable solution as disclosed herein can address challenges which exist with regard to data persistence and dissemination across mixed radio communication architectures/technologies, incompatible data formats, burdensome planning and management tasks, mixed data classification and security enclaves, and an exploding number of communities looking to leverage the “Tactical Internet”. Exemplary embodiments described herein address this problem by offering a service model based solution to data delivery in the form of an EBR device and associated method as detailed below.

### SUMMARY

Embodiments may relate to an edge based routing device configured for a multi-transport network architecture. The edge based routing device may include an edge based routing core having a processor configured for providing service model based data services and utility functions. The edge based routing device may further include a client application programming interface configured for receiving producer application data and for outputting consumer application data. The edge based routing device may further include a proxy application programming interface configured for establishing network layer path selection connectivity between producer applications and consumer applications as a function of network conditions and/or capabilities.

Embodiments may relate to a method for managing communication across multiple networks, between a producer application of a network and a consumer application of a network (e.g., an application executing on a network), using a network edge based routing device. The method may involve receiving a service model based consumer application request for consumer data at the edge based routing device. The method may further involve executing discovery for consumer data across multiple networks via the edge based routing device. The method may further involve receiving discovered consumer data at the edge based routing device from producer applications via multiple networks and a selected transport mechanism suited to a specified one of the multiple networks. The method may further involve providing a list of available data producer applications via the edge based routing device to a consumer application associated with the service model based consumer application request. The method may further involve passing the service model based consumer application request across multiple networks to a producer application. The method may further involve receiving producer application data at the edge based routing device for transport to the consumer application.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements, and in which:

FIG. 1 is a diagram of an exemplary edge based routing device configuration including a software functional allocation as disclosed herein;

FIG. 2 is a flow diagram of an exemplary method for managing communication across multiple networks, between a producer application of a network and a consumer application of a network, using a network EBR device;

FIG. 3 is a notational system view illustrating an exemplary tactical landscape in which an EBR device and EBR network may be implemented;

FIG. 4 is an edge based routing functional architecture which may be implemented and/or modified as disclosed herein with regard to FIG. 1;

FIG. 5 is a diagram of an exemplary edge based routing device data flow as disclosed herein;

FIG. 6 is a diagram of an exemplary message routing using proactive advertisement messages as disclosed herein; and

FIG. 7 is a diagram of an exemplary message routing as performed by a routing engine of an EBR device.

### DETAILED DESCRIPTION

In accordance with exemplary embodiments of the present disclosure, an EBR device solution leverages a service model and transports available to provide resilient access to their data, including any critical data, while minimizing any pre-configuration and management burden, enabling a flexible operational soldier. An exemplary solution not only provides a transport agnostic interface for applications to be able to access the data they need without needing to know the network, but also understands the network and network conditions and capabilities to best perform path selection as well as the content of data being moved to enable enhanced shaping as the data traverses a multi-transport (e.g., tactical) network architecture.

Known tactical data disseminations technologies do not take a service approach model and flexible network awareness concept, resulting in the inability to perform path selection as well as enhanced content shaping to ensure a richest set of data is delivered given current network conditions.

An EBR device as configured to exemplary embodiments disclosed herein provides network aware transport routing in a service model based data delivery architecture to enable resilient access to data and services connected to the dynamic heterogeneous network. It uses content awareness, or knowledge of the data to ensure delivery within transport constraints and moves data over transports using mechanisms that are more efficient given the transport being used at that time.

An exemplary EBR device as disclosed includes a software service model based framework including middleware and at least one API that provides client applications with a means to find and offer data across multi-transport, network architectures using techniques as disclosed herein. Using enhanced network-aware path selection and link monitoring, the EBR device can persist data services while operating in dynamic topologies. To maximize the density of data delivered given network conditions, the EBR device uses enhanced content-aware shaping rules to decrease traffic loading while increased data density without requiring applications to be modified. When applied, for example in capacity-limited network architectures that do not readily or optimally support true end-to-end network-layer connectivity, an increase in resilient data delivery can be achieved to benefit an end user, such as a soldier in a tactical environment. Such enhanced robustness can lead to greater trust in the network architecture (e.g., tactical network architecture).

In accordance with exemplary embodiments, data can be considered as a common commodity for a network. Access to data, and exchange of data, among consumer applications resident on disparate processing devices can be more easily managed when that data is provided as services using a service model based perspective in an ecosystem. As disclosed herein, services are considered a mechanism for users to access specific data through requests such as advertisements or subscriptions (e.g., Common Operating Picture (COP)). Exemplary embodiments as disclosed herein, by using a service model based approach, enable a decoupling of data from: 1) the way the data is provided to consumers; and 2) how data gets transmitted, to support different types of diverse networks. These capabilities can be particularly significant for networks that do not readily or optimally support a true end-to-end network layer connectivity. Services based EBR devices can be thought of as a means to offer new and enhanced data delivery capabilities, for example:
Access to transport and network status information when an alert is observed.
An Electronic Support (ES) sensor that can report Radio Frequency (RF) detections according to request parameters.
Delivery of Situational Awareness (SA) information for a specific area regardless of the network connection type of those populating it with data.

In some embodiments, a service model (e.g., in a service model based application and/or service that may provide data) may refer to a software application and/or network application where one or more consumers (e.g., clients, consumer EBR devices, devices requesting data) may access data that may be available via one or more producers (e.g., producer EBR devices, producers collecting and/or sharing data) via requests for data such that the one or more consumers do not need to be specially configured to access and/or request the data. For example, a service model may include a software application providing data to a plurality of clients where a client device may access and/or request the data from the software application via an internet connection and a web browser. In this example, no additional configuration of the client device is required to allow the client device to access and/or request data from the software application. In this way, the software application may be said to be a service model based software application because the client device may access the data provided by the software application without additional configuration and/or changes to the client device.

In a service model based EBR network, Each EBR device of an EBR network may provide data to other EBR devices within the EBR network in response to requests for data. A service model may further refer to a network of devices (e.g., EBR devices) in which a device that is requesting data may be decoupled from a format of the data such that the device that is requesting (e.g., a consumer device) the data does not need to be specially configured in order to request and/or receive the data from a device that is collecting and/or providing the data (e.g., a producer device) to the device requesting the data. In this way, a service model may allow a plurality of devices in a network request data when data is needed without requiring any special configuration of each device in the plurality of devices. Each device in the plurality of the devices may be unaware (e.g., not specially configured) of a mechanism by which data may be collected, formatted, and/or transported within the network (e.g., a service model based network) or how data is collected, formatted, and/or transported by an application (e.g., a service model based application).

As an example, a service model based data service may include a software application that may expose one or more collections of related information via an interface that may be of interest to a given community (e.g., a community of consumer EBR devices) regardless of the system and/or system configuration that is generating that data (e.g., a sensor, producer EBR device, and/or the like). This related information (e.g., data) may be grouped within an EBR network such that the data is discoverable by a consumer EBR device that may use a service name in a request, without having to specially configure the consumer EBR device. As a further example, a producer EBR device may provide a position report where the position report represents data including a reported location of a user or platform. The position report may include a location, an identification, and a date and/or time. In this way, a consumer EBR device may request a position report by transmitting a request including the service name, and the consumer EBR device does not need to be specially configured to interact and/or interface with the service providing the position report.

Exemplary processor stored consumer applications can achieve enhanced and/or efficient access to discoverable data and services using a series of APIs, as opposed to known network specific mechanisms. Processors configured with such client applications (e.g., consumer applications, producer applications) can leverage the APIs to register and/or advertise capabilities, as well as register and/or advertise data or types of data, the client applications may possess in local or remote (e.g., cloud or centralized database) storage devices (e.g., any available hardware memory) for other processor based devices to find and access.

Furthermore, through this same API, processor based applications can perform data service and/or sensor discovery or requests for data or services of interest to a select user or processor based data consuming device.

In some embodiments, a producer application may refer to a software application (e.g., software instructions) executing on a processor of an EBR device (e.g., a producer EBR device), where the EBR device may collect data (e.g., via one or more sensors) for providing to other EBR devices (e.g., consumer EBR devices) in an EBR network. A producer application may manage the collection of data of the EBR device and/or manage a sensor of the EBR device that is configured to collect data (e.g., a camera of the EBR device). A producer application may be configured to manage producer application data residing on the EBR device that is collecting data, and a producer application may include one or more interfaces such that producer application data residing within the producer application may be shared and/or transmitted to the EBR device such that the EBR device may share the producer application data with the other EBR devices in the EBR network. For example, the producer application data may be accessible to consumer EBR devices via a service model based data service associated with the producer application data. The service model based data service may be discoverable by consumer EBR devices through an EBR service framework that lists available data services.

In some embodiments, a producer application may include any software program, software application, and/or system that may generate data that is being offered (e.g., via an interface) to be accessible to consumer applications within an EBR network. Means of enabling delivery of the data to consumer applications may be accomplished by associating the data with a data service in an EBR network and offering the data via the data service. The data service may be discoverable through an EBR service framework, where the EBR service framework includes a list of a plurality of data services that may be offered to EBR devices in the EBR network.

In some embodiments, a consumer application may refer to a software application (e.g., software instructions) executing on a processor of an EBR device (e.g., a consumer EBR device), where the EBR device may request and/or retrieve data from other EBR devices (e.g., producer EBR devices) in an EBR network. A consumer application may manage the retrieval of data of the EBR device and/or may manage a use of the data in the consumer application. For example, a consumer application may receive producer application data from a producer EBR device and the consumer application may use the data to generate an output, such as an output to display a GUI element (e.g., a chart, a picture, and/or the like) such that the data is viewable by a user of the EBR device. Additionally or alternatively, a consumer application may use the producer application data to perform an analysis and generate an output from the consumer application to the EBR device. A consumer application may be configured to manage consumer application data residing on the EBR device that is receiving producer application data, and a consumer application may include one or more interfaces such that producer application data may be shared and/or transmitted from the other EBR devices such that the EBR device may share the producer application data with the consumer application. For example, a consumer application executing on a consumer EBR device may have interest in receiving or accessing producer application data that has been made available by a producer EBR device. The consumer application may access and/or receive the producer application data via discovery of a data service associated with the producer application data of the producer application of the producer EBR device. Using a request including the name of the data service, the consumer EBR may access and/or receive the producer application data that is made available by the producer EBR device.

In some embodiments, a consumer application may include any software program, software application, and/or system that may have an interest in receiving and/or accessing data that has been made available by a producer application within an EBR network. Means by which a consumer application may receive data generated by a producer application (or generated via sensors associated with a producer EBR device) may be accomplished via discovery of the associated data service within the EBR network. That is, a consumer application may discover the associated data service by transmitting a request requesting data. The consumer application may receive a list of data services that could provide the data in the request via discovery of associated data services.

In some embodiments, producer application data may refer to data that is collected and/or maintained by a producer application executing on an EBR device acting as a producer (e.g., a producer EBR device). For example, an EBR device acting as a producer may collect data and transmit data to a consumer EBR device that requested the producer application data. Producer application data may reside in the producer application executing on the EBR device acting as a producer.

In some embodiments, consumer application data may refer to data that is received and/or maintained by a consumer application executing on an EBR device acting as a consumer (e.g., a consumer EBR device). For example, an EBR device acting as a consumer may request data from one or more producer EBR devices and the EBR device acting as a consumer may receive the data that was requested form the one or more producer EBR devices. The consumer application data may reside in the consumer application executing on the EBR device acting as a consumer.

Although producer application, consumer application, producer application data, and consumer application data are described herein as residing on and/or executing on a producer EBR device and/or a consumer EBR device, the role of an EBR device in the EBR network may include a producer, a consumer, or both a producer and a consumer at a given instance depending on actions of the EBR device. Thus, the terms producer application, consumer application, producer application data, consumer application data, producer EBR device, and consumer EBR device should not be limited to a specific EBR device and may be appropriately applied in situations where an EBR device in an EBR network is acting as a producer, a consumer, or both a producer and a consumer.

Decoupling applications and transports are one improvement offered by the EBR device and EBR network. This decoupling can be configured as described herein to enable a significant advantage of being able to provide a transport agnostic interface for user-facing applications without them needing to know the network. This understanding of the network, its conditions, and capabilities, allows for robust performance of path selection and enhanced shaping of data as the data traverses the multi-transport tactical fabric.

An EBR device as disclosed herein provides an innovative approach to handling data discovery and dissemination in denied, degraded intermittent or limited (DDIL) and/or disadvantaged, disconnected, intermittent or limited (DDIL) network architectures. In order to persist reliable dissemination of data, novel EBR approaches as disclosed herein leverage one or more of the following tenets in an integrated fashion to address current data transport challenges, such as those facing the US DoD in tactical operation. Four exemplary innovative techniques adopted in accordance with exemplary embodiments of an EBR device as disclosed herein are:
Data Through Services: Exemplary embodiments can exploit a service model based approach of data delivery to provide an EBR device as a means to discover, advertise and access data across a communications fabric, such as a tactical communications fabric via, for example, Geo-based Publish/Subscribe, Request/Response, and other asynchronous model mechanisms.
Network Aware Transport Routing: Exemplary embodiments can provide resilient access to data and services connected to the dynamic heterogeneous (e.g., tactical) network (e.g., U.S. Army Integrated Tactical Network (ITN) Capability Set Architectures).
Content Aware Data Shaping: Exemplary embodiments can ensure delivery of a richest data possible given network conditions and capabilities through novel content shaping in a service model based environment.
Transport Agnostic, But Aware Operation: Exemplary embodiments can provide services using lightweight, transport friendly mechanisms without burdening applications with a need to be aware.

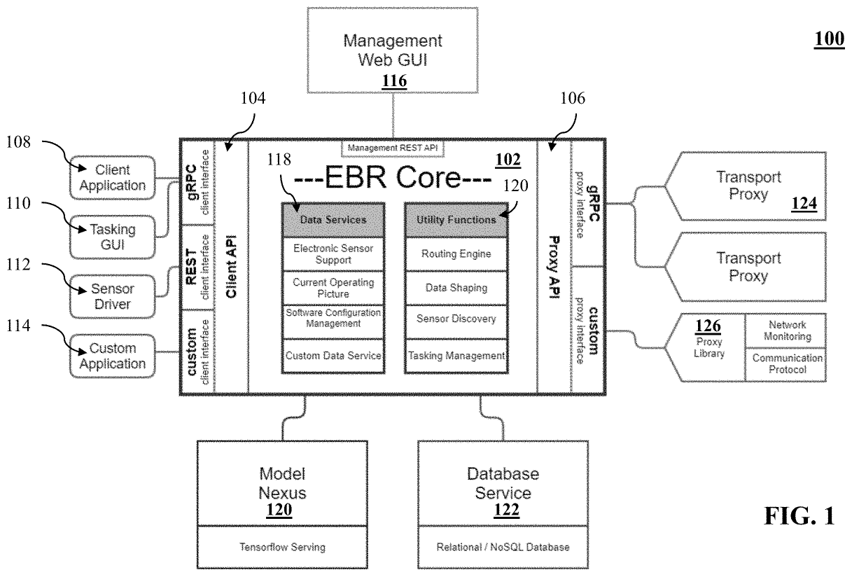

FIG. 1 illustrates an exemplary functional allocation of a service model based EBR device node containing software modules (e.g., applications, services, microservices, and/or the like) configured on hardware pursuant the present disclosure, the EBR device being within a system containing processor based applications that would use the EBR data service framework. The various components of FIG. 1 may be implemented in a common processor or on any number of interconnected dedicated processors with attendant memory and communications I/O interface devices. Each of the components shown in FIG. 1 will be described in the context of an exemplary embodiment.

Referring to FIG. 1, embodiments relate to an edge based routing (EBR) device configured for a multi-transport network architecture including a software functional allocation configuration 100 as disclosed herein. The EBR device configuration 100 may include EBR core 102 having a processor configured for providing service model based data services and utility functions. The EBR device configuration 100 may include client application programming interface (API) 104 configured for receiving producer application data and for outputting consumer application data. The EBR device configuration 100 may include proxy API 106 configured for establishing network layer path selection connectivity between producer applications and consumer applications as a function of network conditions and/or capabilities.

A service model based data service may include a software application (e.g., software instructions) executing on a processor, where the software application may cause a processor to provide (e.g., expose, to other applications, interfaces, and/or the like) a collection of related information (e.g., data) that may be of interest to a given community regardless of the system that is generating that information. Data may be grouped within an EBR network to be discoverable using a service name associated with a group of data. For example, position reports may reflect a reported location of a user or a platform. A position report may include a location, an identification, a data, and/or a time.

With continued reference to FIG. 1, EBR device configuration 100 may further include client application 108, tasking graphical user interface (GUI) 110, sensor driver 112, and one or more custom applications 114, each executing on the processor of the EBR device. EBR core 102 may execute on the processor of the EBR device. EBR core 102 may include associated microservice applications, such that EBR core 102 may communicate with the one or more client applications 108, tasking GUI 110, sensor driver 112, and the one or more custom applications 114 executing on the EBR device. In some embodiments, EBR core 102 and associated microservice applications may communicate with one or more client applications 108, tasking GUI 110, sensor driver 112, and one or more custom applications 114 executing on another EBR device connected to an EBR network. The EBR device including EBR device configuration 100 may communicate with other EBR devices within an EBR network via client API 104 and/or proxy API 106 included to support EBR core 102.

EBR core 102 of the EBR device may be in communication with management web graphical user interface (GUI) 116, model nexus 120 (e.g., Tensorflow Serving), and database service 122 (e.g., a relational database, NoSQL database, and/or the like). Management web GUI 116 may include a microservice web dashboard. Management web GU 116 may provide a user control and/or access to initial and/or configure an EBR instance, EBR core 102, and/or an EBR device. For example, management web GUI 116 may allow a user to modify runtime settings on an EBR device while the EBR device is connected to a live EBR network. The user may modify settings such as data shaping functions. Additionally, the user may view live statuses of EBR core 102 and the EBR network including a plurality of EBR nodes.

Model nexus 120 may include a microservice application that may allow edge inference and management of machine learning models. Exemplary Model Nexus 120 may be built around an open-source inference engine, such as Tensorflow Serving, which is a part of the Tensorflow Extended (TFX) architecture. Model Nexus 120 may support serving and unserving of machine learning models for use by EBR 102. Model nexus 120 may return an inference based on data from EBR core 102. Model nexus 120 may use custom processing functions and custom trained machine learning models to generate inferences for EBR core 102. Model nexus 120 may transmit any inferences that are generated to EBR 102 for processing and/or consumption.

Model nexus 120 may also implement a Data Drift Service utilizing a Tensorflow Data Validation library. The Tensorflow Data Validation library may detect schema drift by comparing a schema of training data using a TFX component called SchemaGen and a schema of serving data to check for data error and/or anomalies. TFX may also detect data skew and/or data drift by comparing statistics of training data using a TFX component called StatisticsGen and the statistics of the serving data. Data drift may be an optional service for data requests and therefore the Data Drift Service may be initiated when, for example, the Data Drift service is requested as part of an EBR tasking or a local client interfacing directly with TFX.

Data drift service may be asynchronous with a model serving service of model nexus 120 and may be turned off if not desired. Data drift may include a trigger for capturing and retaining training data to be used for anomaly detection and/or model retraining. The detection of data drift and anomalous data capture may result in a delivery of captured data if network conditions permit. Otherwise, a notification of alerts and the collected data may be sent to requesting consumer EBR devices.

Database Service 122 may include a microservice application that may allow EBR core 102 to communicate with a database (e.g., a database the same as or similar to data store 412). Database service 122 may include a layer of abstraction that may allow for easier cross-platform support and the use of a variety of different databases without having to specially configure EBR core 102, the EBR device, and/or database service 122. Database service 122 may include functions for working with EBR tables such as clients, nodes, and taskings, as well as any data service-specific tables. Data service-specific tables may be initialized and interacted with by extending an abstract class provided by the EBR Software Development Kit (SDK) (e.g., Centera SDK). Exemplary database service 122 may be associated with a relational database, a NoSQL database, or another suitable type of database.

EBR core 102 of EBR device configuration 100 may further include one or more data services 118 such as electronic sensor support, current operating procedure, software configuration management, one or more custom data services, and/or the like. EBR core 102 may further include one or more utility function engines 120 such as a routing engine, a data shaping engine, a sensor discovery engine, a tasking management engine, and/or the like. EBR core 102 may interface with one or more client interfaces (e.g., client application 108, tasking GUI 110, etc.) through client API 104 and an associated Google Remote Procedure Call (gRPC) client interface, an associated REST client interface, one or more custom client interfaces, and/or the like. EBR Core 102 may interface with one or more transport proxies 124 and/or proxy library 126 through proxy API 106 and an associated gRPC interface, one or more custom proxy interfaces, and/or the like.

Client applications 108 executing on an EBR device may look to consume specific data. An EBR device executing a client application 108 that is operating to consume data may be referred to as a consumer device (processors), or “consumers”. Client applications 108 executing on an EBR device that may have data to offer (e.g., transmit) to other consuming client applications. An EBR device executing a client application 108 that is operating to produce data may be referred to as a producer device (processors), or “producers”. A single processor based client application (e.g., client application 108) executing on an EBR device may be both a consumer and producer.

EBR core 102 may include one or more utility functions 120 as described herein. The one or more utility functions 120 may permit data that is available for consumption by producers to be dynamically discovered, requested, and delivered to consumers across a network architecture without either the consumer and/or producer needing to be aware of the mechanisms by which the exchanged data is moving between them. For example, EBR core 102 may implement one or more client interfaces (e.g., client API 104) such that a consumer and/or a producer need only request and/or transmit data, without knowing a location of the data, an availability of the data, transport protocols, data formats, and/or other factors. Utility functions 120 may include a routing engine, a data shaping engine (e.g., data shaping), a sensor discovery engine (e.g., sensor discovery), and a tasking management engine (e.g., tasking management).

In some embodiments, the EBR device (e.g., EBR core 102 thereof) may be configured as a service model which may produce data requests as a function of consumer processor based services. EBR core 102 may determine paths of a network architecture (e.g., one or more network paths) over which the data requests will be transported.

In some embodiments, the EBR device (e.g., EBR core 102 thereof) may be configured for a dynamic, heterogeneous tactical network architecture.

In some embodiments, the EBR device (e.g., EBR core 102 thereof) may be configured to perform dynamic data discovery based on proactive advertisement messages. EBR core 102 may be configured to disseminate data based on data requirements of consumer processor based services, the data being shaped with a desired data density.

In some embodiments, the EBR device (e.g., EBR core 102 thereof) may include proxy API 106 configured to provide transport mechanism agnostic messaging, which will support transport proactive advertisement messages.

In some embodiments, the EBR device (e.g., EBR core 102) may be configured to access data of producer processors using data requests and/or subscriptions.

In some embodiments, the EBR device (e.g., EBR core 102 thereof) may be configured to perform dynamic data discovery and to access transport and network status information when an alert is observed and/or a sensor reports an alert with respect to request parameters.

In some embodiments, the EBR device (e.g., EBR core 102 thereof) may be configured to perform dynamic data discovery, in combination with an edge based routing device of a consumer processor and edge based routing device of a producer application.

In some embodiments, the EBR device (e.g., EBR core 102 thereof) may be configured to assemble situational awareness information received from producer applications for a specified area in a tactical network environment.

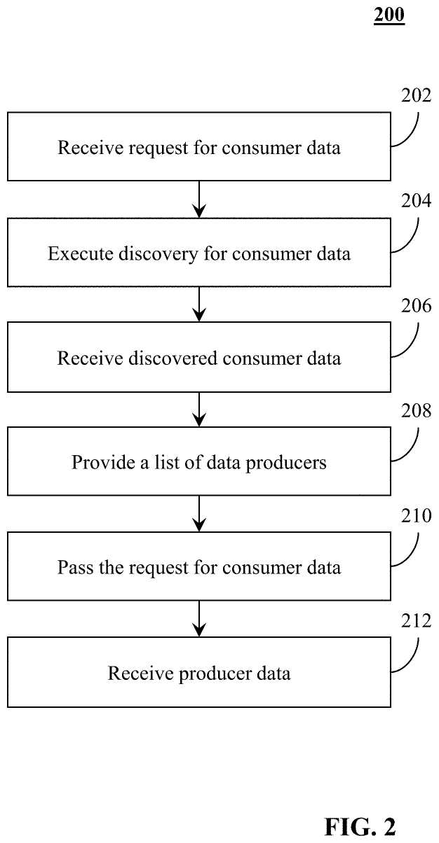

Referring to FIG. 2, embodiments of a method 200 is also disclosed for managing communication across multiple networks, between a producer application of a network and a consumer application of a network, using a network edge based routing device being configured for a multi-transport network architecture. The steps shown in FIG. 2 are for example purposes only. It will be appreciated that additional, fewer, different, and/or a different order of steps may be used in some embodiments.

Method 200 may involve step 202 including receiving a request for consumer data. For example, EBR core 102 of an EBR device may receive a service model based consumer application request for consumer data.

Method 200 may further involve step 204 including executing discovery for consumer data. For example, EBR core 102 may execute discovery for consumer data across multiple networks via the EBR device.

Method 200 may further involve step 206 including receiving discovered consumer data. For example, EBR core 102 may receive discovered consumer data at the edge based routing device from producer applications via multiple networks and a selected transport mechanism suited to a specified one of the multiple networks.

Method 200 may further involve step 208 including providing a list of data producers. For example, EBR core 102 may provide a list of available data producer applications via the edge based routing device to a consumer application associated with the service model based consumer application request.

Method 200 may further involve step 210 including passing the request for consumer data. For example, EBR core 102 may pass the service model based consumer application request across multiple networks to a producer application.

Method 200 may further include step 212 including receiving producer data. For example, EBR core 102 may receive producer application data at the edge based routing device for transport to the consumer application.

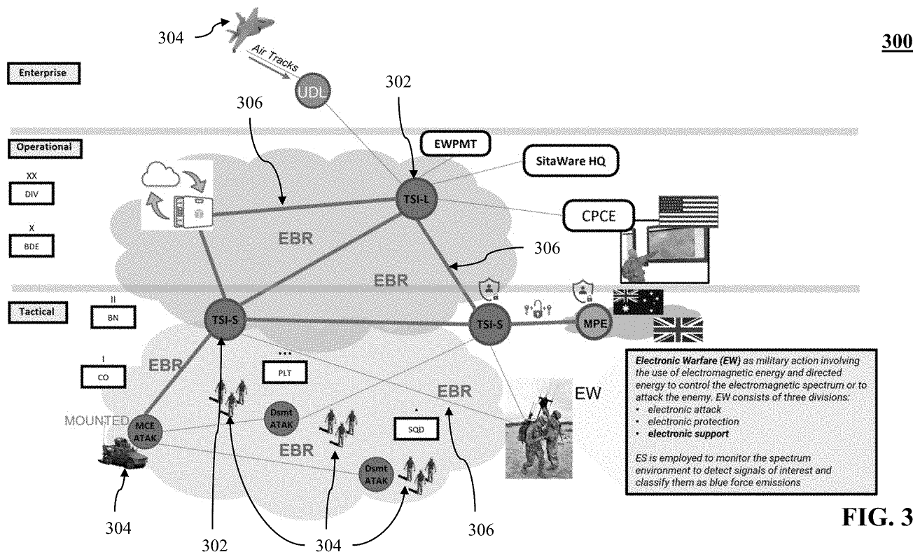

Referring now to FIG. 3, shown is an exemplary tactical system 300 wherein connections among distributed sensors, shooters, and data in all domains, to all forces, may allow for distributed command and control at a scale, tempo, and level to accomplish a commander's intent. System 300 may be configured to be agnostic to domains, platforms, and functional-mission lanes. System 300 may include one or more networks, such as networks 302, facilitated by a plurality of EBR devices and one or more data sources 304 and/or data consumers 304 each connected through EBR connections 306 of an EBR network.

FIG. 3 is an exemplary view of systems and echelons to demonstrate technologies that will enable a digital battlespace with the implementation of EBR devices and EBR networks. For example, data from data sources 304 (e.g., producers and/or consumers) may be collected via automated sensors and such data may be used to make broad, informed decisions. The use of EBR devices along with the EBR network may allow for the collection and use of data from various data sources 304 automatic and seamless between EBR devices, sensors, and applications executing on EBR devices within the EBR network. Additionally, the use of EBR devices within the EBR network may reduce the need for continually updating configurations of devices and frameworks, such as EBR core 102.

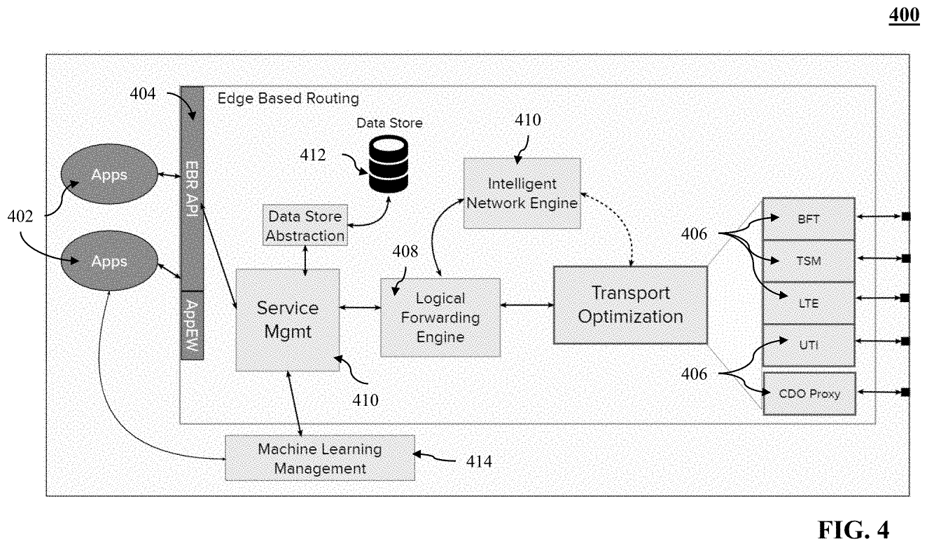

Referring now to FIG. 4, shown is an EBR functional architecture 400 that may be implemented and/or modified as disclosed herein with regard to exemplary functional allocation of FIG. 1. Within an EBR network, one or more applications 402 (e.g., client application 108) may make requests for data through EBR API 404. EBR functional architecture 400 may include one or more transport proxies 406 that may be responsible for performing service-specific actions such as message format compliance and reporting network status (e.g., stat) conditions. A path selection process may be performed by Logical Forwarding Engine (LFE) 408, which may be populated with transport status from Intelligent Network Engine (INE) 410. As transport conditions change (e.g., networks degrade, or EBR nodes are no longer reachable), the EBR framework may heal network path(s) to persist flow of data and/or messages. Applications 402 are not required to be involved or aware of the path selection process.

With continued reference to FIG. 4, exemplary additional varied input interfaces may include sensor and configuration data via transport proxies 406 including a Blue Force Tracker (BFT) interface, a Cross Domain Operation (CDO) proxy, a Long Term Evolution (e.g., 4G) cellular interface, a Tactical Scalable MANet (TSM) interface, and an Upper Tactical Internet (UTI) interface. EBR functional architecture 400 may further include service management engine 410, data store 412, and machine learning management engine 414. One or more components of FIG. 4 may be the same as or similar to components shown in FIG. 1. For example, transport proxies 406 may be the same as or similar to one or more transport proxies 124 shown in FIG. 1.

In addition to providing dynamic discovery and dissemination of data across highly dynamic network architectures, EBR functional architecture 400 may include provisions to discover and disseminate data across security enclaves separated by Cross Domain Solutions (CDS). This capability dynamically formats data and messaging into the type supported by CDS policy (e.g., eXtensible Markup Language (XML)), and obfuscates or filters data to ensure the data meets specified requirements of accredited policies. EBR functional architecture 400 may provide an ability to discover and task sensor platforms operating on different classifications from the same workstation. Signal detections can be populated back and presented on a single display to depict the electromagnetic conditions of the battlespace more intuitively.

EBR functional architecture 400 may be developed in java and may be configured to operate within Linux, Windows, and/or Android environments. For example, EBR functional architecture 400 may be configured to operate in conjunction with Android Tactical Assault Kit (ATAK). EBR functional architecture 400 may be integrated into the Common Operating Environment-Command Post (COE-CP) and developmental Common Operating Environment-Mounted Computing Environment (COE-MCE) applications. For example, EBR functional architecture 400 may be integrated into COE-CP application executing on one or more processors within an operating system.

With reference to EBR core 102, EBR core 102 may be configured to be responsible for managing a relationship and data exchange between external processes or client applications on processor based devices across a network communications fabric (e.g., network architecture) that connects platforms for the purpose of exchanging data. Client applications are interfaced via one or more client APIs and associated gRPC client interfaces, Representational State Transfer (REST) client interfaces, and/or any custom client interfaces desired. In some embodiments, example data services of EBR core 102 may be supported by software modules (e.g., software instructions) which provide electronic sensor support, current operation picture (e.g., COP), software configuration management, and any desired custom data services. Utility Functions of EBR core 102 are supported by software modules which provide a routing engine functionality, data shaping, sensor discovery, tasking management functionality and so forth.

The routing engine may include software instructions (e.g., a software application, a software component, and/or the like) that may be executed on at least one processor of an EBR device (e.g., a device implementing device configuration 100). The routing engine may be configured to cause a processor of the EBR device to select one or more network paths for transmitting one or more messages (e.g., routing message objects) from one or more initial points (e.g., consumers and/or producers) to one or more intended destinations (e.g., consumers and/or producers). A network path may include at least one source node (e.g., a source point in the network, a transmitting EBR device) and at least one target node (e.g., an intended destination, a receiving EBR device). In some embodiments, a network path may include at least one source node, one or more intermediate nodes, and at least one target node. A node within a network may include an EBR device (e.g., an EBR device node).

The routing engine may have access to a target destination list used with routing message objects. The target destination list may include a list including each target node connected to the one or more networks paths that the source node is connected to. For example, the target destination list may include an entry for each target node that the source node may transmit a message to through a network path. For each target node in the list of destinations, the routing engine may look up the network path to the target node in EBR data store 412 shown in FIG. 4. The routing engine may select the network path having a largest capability rank when compared to other network paths in EBR data store 412. A capability rank may include a measure of capability for a network path. The capability rank may refer to a measure that is determined based on several network factors including, but not limited to, network capacity, network latency, observed loss within a network, transport congestion within a network, and signal strength of a network (e.g., a signal strength as measured at an EBR device that is transmitting a message). The capability rank may include a rank specific to a transport and/or a network path, since not all transports can be assessed using the same network factors.

The routing engine may select the one or more network paths based on a greatest efficiency (e.g., a measure of efficiency based on transmission speed, a number of transmitted messages, a number of nodes that the transmitted message must pass through to reach the target node, etc.). For example, the routing engine may select a network path that has a greatest efficiency for transmitting one or more routing message object to one or more target nodes based on a number of intermediate nodes. In some embodiments, the one or more network paths having a greatest efficiency may change over time. The routing engine may detect a change in the one or more network paths and/or a change in the greatest efficiency of the one or more network paths and the routing engine may dynamically determine a new network path to transmit a message as network conditions change.

To determine the one or more network paths based on the greatest efficiency, the routing engine may split the one or more routing message objects into a plurality of message segments based upon the target node, a next hop node (e.g., an intermediate node connected to the source node where the routing message object can be transmitted to), and a type of network to transmit the one or more routing message objects from a source node to a target node. For example, the routing engine may transmit each message segment of the one or more routing message objects over a network path having a network type such that the delivery of the one or more routing message objects to the one or more target nodes is maximized and a number of message transmissions is minimized. A message transmission may refer to a first node transmitting a message to a second node. In this way, routing engine may minimize the number of message transmissions by transmitting the one or more message segments from the source node to the target node where the network path selected includes a minimum number of intermediate nodes (e.g., each message segment passes through a minimum number of intermediate nodes).

The routing engine may then select the network path for a routing message object having the least number of intermediate nodes. Routing engine may transmit routing message objects to multiple destinations (e.g., multiple target nodes) from one source node (e.g., one EBR device) using a transport protocol such as multicast, or other transport protocol compatible with the networks. In this way, the routing engine may cause EBR core 102 to determine what network path(s) messages should be exchanged/passed over for efficient routing of messages between EBRS devices of producers and EBR devices of consumers.

Through the routing engine of EBR core 102, the network paths between consumers and producers may be discovered during a discovery process initiated by the sensor discovery engine. The sensor discovery engine may disseminate one or more EBR discovery messages across all transport protocols available to an EBR node via transport proxy 318.

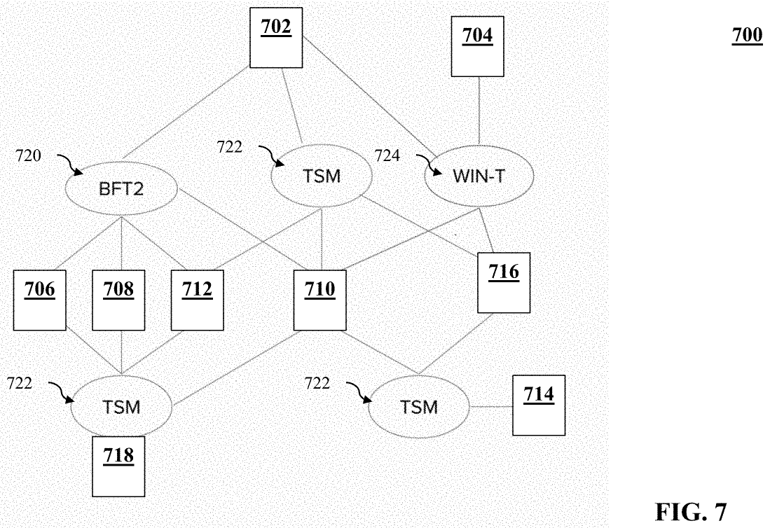

Referring to FIG. 7, shown is a diagram of an exemplary message routing as performed by a routing engine of an EBR device within an exemplary EBR network 700. A client EBR device representing node 702 may determine to transmit a message to a plurality of target nodes (e.g., node 710, node 716, and 718). When a client EBR device connected to the EBR network at node 702 issues a discovery request for data, if an active tasking is not already found in the task management engine, EBR core 102 of the EBR client device connected at node 702 may execute a discovery operation across available networks (e.g., BFT2 network 704, TSM network 706, and/or Warfighter Information Network-Tactical (WIN-T) network 708). The discovery request may be propagated across multiple hops (e.g., across one or more intermediate nodes) to enable discovery of all sources available within the EBR network. Once the paths are established, the EBR routing engine may perform the hop-by-hop dissemination of data (e.g., from node 702 to node 716, from node 702 to node 710, to node 714, and from node 702 to one of nodes 706-708-712, to node 718), adhering to the data shaping rules and protocols/encoding for each transport.

With continued reference to FIG. 7, as an example, an EBR message originating from an EBR device connected to the EBR network at node 702 may identify three target nodes (e.g., three destinations) in a list of target nodes with the routing engine: EBR clients connected to the EBR network residing at node 710, node 716, and node 718. In this example, the following steps will be taken:

For each node in the list of target nodes, the routine engine of the EBR device residing at node 702 may look up the best route (e.g., network path) to each target node in the EBR database (e.g., EBR data store 412). Best route may refer to a network path having a greatest capability rank. For example, if two network paths have the same capability rank, the routing engine of the EBR device residing at node 702 may select the network path with a least number of hops (e.g., a least number of intermediate nodes). The client EBR device residing at node 702 may (e.g., the routing engine thereof) may map each next hop of a plurality of next hops to the list of target nodes. Thus, an example map may include:

Target node 710:next hope node 710, target node 716:next hop node 716, target node 718:next hop node 710. For any next hop nodes that are over a proxy that supports multicast, a single proxy message may be used. In this example: a single message can be sent that will be received on node 710 and node 716 over TSM network 722.

When the message transmitted from the client EBR device residing at node 702 is received at an EBR device residing at node 716, the EBR device residing at node 716 will handle the message. When the message is received by an EBR device residing at node 710, the EBR device residing at node 710 will handle the message. The message may also contain information and/or signals causing the EBR device residing at node 710 to forward the message to an EBR device residing at node 718, as node 710 is an intermediate node (e.g., a next hope node) for the network path from node 702 to node 718.

The routing engine may continuously monitor the network (e.g., one or more network paths of the EBR network) for a first network path from a source node A to a target node B for a message to be transmitted. In a multi-hop transport topology (e.g., one or more intermediate nodes), the first network path may degrade. In this instance, the routing engine of the EBR device may identify another network path that may allow the EBR system to maintain a same degree of connectivity as the first network path before the first network path had degraded. The routing engine may identify another network path by applying a new set of data shaping rules to data associated with the message to be transmitted. Alternatively, the routing engine may change a protocol and/or encoding of the data associated with the message as it traverses the EBR network. Additionally, because the EBR device may constantly monitor the networks of the EBR network using the routing engine, if the first network path that previously had degraded subsequently returns to an initial status and/or connectivity before the message is transmitted, the EBR device may detect that the first network path has returned to the initial status and the EBR device may switch back to the first network path and identify the first network path as a network path for transmission of the message where the first network path provides for an improved transmission (e.g., greatest efficiency, highest capacity, least degraded connectivity, fastest transmission compared to other network paths, and/or the like) of the message.

A data shaping engine (e.g., data shaping engine of EBR Core 102) may include software instructions (e.g., a software application, a software component, and/or the like) that may be executed on at least one processor of an EBR device (e.g., a device implementing device configuration 100). The data shaping engine may be configured to cause at least one processor of the EBR device to shape data included in a routing message object, where the routing message object is a message object including data associated with the message object (e.g., a data message object). Shaping data and/or a function to shape data (e.g., a shaping function) may refer to an action of reducing total network capacity required and/or capacity of a network path required to transmit data between EBR device nodes to align with capacity conditions of the network being used for transmission. The data shaping engine may use one or more parameters to shape data and the one or more parameters may be configured on each EBR device node.

The data shaping engine may shape data included in a data message object based on a capability rank of a network path that the data message object is transmitted over. For example, a network path may have a capability rank associated with the network path representing a capability and/or capacity of the network path to transmit data. In some embodiments, the capability rank of a network path may include an integer value. EBR Core 102 (e.g., at least one processor of EBR Core 102) may determine the capability rank associated with a network path when a message object is transmitted and/or routed to go to another EBR device node (e.g., a target node) over the network path (e.g., the selected network path, selected by the routing engine). For example, a capability rank of the network path may be established for the network path. Additionally, the data shaping engine may continually monitor the capability rank for the network path. The data shaping engine may shape data associated with data message objects transmitted over the network path based on the capability rank. For example, the data shaping engine may determine how data associated with a data message object is shaped to ensure the data can be transmitted through the network path without oversubscribing the network path (e.g., transmitting one or more data message objects over the same network path causing the network path to reach and/or exceed a capacity of transmission).

As an example, a COP message including an observation report, the COP message containing an image (e.g., image data), may be transmitted over a network path having a capability rank of 8. Before transmitting the COP message to the transport proxy, the data shaping engine may analyze a shaping configuration such that the data shaping engine may determine a shaping function that may be used based on the capability rank of 8 of the network path. The data shaping engine may call the shaping function to transform the COP message of the observation report such that the COP message may be transmitted over the network path more efficiently. The shaping function in the configuration, for example, may be set to compress the image in the COP message by 50% to generate a resulting observation report of the COP message. The data shaping engine may then transmit the COP message with the resulting observation report to a target node.

Additionally, the data shaping engine may determine how and/or what data may be sent over a network path based on changes in network conditions. For example, the data shaping engine may average data associated with a message to be transmitted and/or the data shaping engine may limit the size and/or amount of data transmitted in a message. The data shaping engine may determine how to shape data based on rules associated with a message type of the message which may be defined within the data service. For example, the data shaping engine may increase a period of message transmission to reduce a frequency that the message is transmitted where the data associated with the message represents a position of an object and/or a device. As a further example, the data shaping engine may compress data associated with the message where the data represents a video stream. In other instances, data associated with a message may be averaged over time based on the type of the data and the needs of the consumer devices. As new types of data are introduced into the EBR system, the data shaping engine may be configured to process and/or recognize the new types of data.

A sensor discovery engine (e.g., sensor discovery of EBR Core 102) may include software instructions (e.g., a software application, a software component, and/or the like) that may be executed on at least one processor of an EBR device (e.g., a device implementing device configuration 100). The sensor discovery engine may be configured to cause at least one processor of the EBR device to find one or more producer clients (e.g., producers) that may be capable of providing a sensing and/or data collection capability. The sensor discovery engine may assist a consumer to determine and/or find data that may be available from one or more producers when the data and/or the one or more producers are unknown to the consumer. A consumer within the EBR network may invoke a function to call the sensor discovery engine of EBR core 102 to search for data based on a plurality of parameters. The plurality of parameters may include data parameters defined in the data service that may be associated with a sensor of one or more producers and/or data parameters which may be standard data parameters (e.g., geographic location, and/or the like). For example, one or more producers may have radio frequency sensors. The data parameters that may be identified and/or found by the sensor discovery engine may include geographical location, radio frequency spectrum coverage, and/or various machine learning model capabilities such as modulation classification.

As an example, a consumer may transmit a sensor discovery message via the EBR network, the sensor discovery message requesting a list of radio frequency sensors located in a specific geographical location where the radio frequency sensors are capable of performing signal classification of signals between 550 MHz and 1000 MHz. The sensor discovery engine may then identify and/or find available radio frequency sensors and may return the list of radio frequency sensors to the consumer, along with capabilities of each radio frequency sensor.

In some embodiments, a consumer client EBR may subscribe to an EBR application of a producer client EBR device based on a discovery message transmitted from the client consumer EBR device. For example, once the sensor discovery engine returns a list of sensors and/or data producers to the client consumer EBR device, the client consumer EBR device may subscribe to one or more sensors and/or data producers such that the client consumer EBR device will receive all data updates and/or all data collected by the client producer EBR device collecting data with the one or more sensors.

A tasking management engine (e.g., tasking management of EBR core 102) may include software instructions (e.g., a software application, a software component, and/or the like) that may be executed on at least one processor of an EBR device (e.g., a device implementing device configuration 100). The tasking management engine may be configured to cause at least one processor of the EBR device to track EBR nodes having various attributes and/or capabilities. For example, the tasking management engine may track EBR nodes that may be discovered by the sensor discovery engine and the tasking management engine may track the EBR nodes having certain capabilities.

Additionally, the tasking management engine may track and/or identify active consumers requesting data, producers that may be providing data, and active service sessions that are actively transmitting data from consumers to producers. For example, consumers and producers may perform various tasks in order to participate in data exchange with other consumer and/or producer nodes. The tasking management engine may determine if new discoveries are able to be satisfied with existing taskings. For example, if there are two clients, client A and client B, on the same EBR node, and client B is attempting to discover data that has already been previously provided to client A, the tasking management engine may provide the data that has already been previously provided to client A to both client A and client B without requiring a discovery and tasking process. Alternatively, the tasking management engine may provide the data that has already been previously provided to client A to client B after the data has already arrived at client A, such that the same data does not need to be transmitted to client B from the original producer of the data.

Tasks managed by the tasking management engine may include specific functions such as: registration. For example, the tasking management engine may track and/or manage which EBR devices possesses which types of data and/or capabilities that the EBR device provides the EBR network. The capabilities that may be tracked by the tasking management engine may include capabilities such as sensing, image capturing, and/or the like. The tasking management engine may track and/or manage the EBR devices within the EBR network by maintaining a list of one or more registered clients residing on an EBR node.

As an example, a client device (e.g., a client EBR device) including a RF sensor may be registered by the tasking management engine of the ERB core 102 as an Electronic Support Sensor (ESS) producer providing a data service including RF sensor data. When registering the client device, the tasking management engine may collect and/or maintain information specific to ESS and data service provided by the client device, such as an available frequency range of the RF sensor, and use of signal classification by the RF sensor.

After client devices are discovered through a discovery process performed by the sensor discovery engine, the tasking management engine of a consuming client device (e.g., a consumer) may generate a task request and the consuming client device may transmit the task request to a producer client device. The task request may include a task signal (e.g., a flag, a function, and/or the like), the task signal causing a producer client device (e.g., a producer) to perform a task such as providing the consuming client device with data that the consuming client device had requested via a tasking request and/or data that the consuming client device had previously requested. Tasking requests may include a set of parameters defined by the data service and tasking requests may include one or more task signals associated with a list of client devices where a task signal of the one or more task signals may be transmitted to each client device in the list of client devices such that each client device is caused to perform a task (e.g., provide data to a consuming client).

A client EBR device may identify (e.g., by performing a look-up operation) each client device to include in a list of client devices to transmit a task request, and the client EBR device may transmit the task request to the target node of each client device. Each client device in the list of client devices that receives a task request may provide data that matches the task request parameters such that the data that matches the task request may be routed back to the consumer client (e.g., the client EBR device) that transmitted the tasking request. The tasking management engine may monitor a state of a tasking session such that all tasking requests of a client device (e.g., either tasking requests that are transmitted or tasking requests that are received by a client device) are tracked and/or recorded. A tasking session may refer to a two-way communication link between a consumer client device, a producer client device, and/or another device that is delimited by an amount of time.

For example, a producer client device may establish a tasking session with a vehicle to monitor a status of the vehicle (e.g., fuel level, engine status, and/or the like). The status of the vehicle and status of the tasking session may be registered with the task management engine executing on the producer client device. When the producer client device receives a task request to provide the status of the vehicle to a consumer client device transmitting the task request, the task request is managed (e.g., processed, monitored, recorded, etc.) by the tasking management engine executing on the producer client device.

With the one or more Utility functions of EBR core 102, data that is available for consumption by producers can be dynamically discovered, requested and delivered to consumers across a network architecture without either the consumer or producer needing to be aware of the mechanisms by which the exchanged data is moving between them.

An EBR device (e.g., an EBR device implementing device configuration 100) may be content aware. That is, the EBR device may be aware of content formats and a producer EBR device may define a structure of data that the producer EBR device may transmit over one or more EBR networks. One or more EBR devices connected to the EBR network may access all data values within the EBR network, regardless of how the structure of the data is defined. The ability to access data regardless of the structure of the data differs from transmitting data simply as a payload.

With the EBR device, a producer may explicitly define a data structure and the EBR device may define the data structure within the EBR networks and the data structure that may be accessed by consumer EBR devices. In this way, data structures do no need to be inferred based on other techniques such as packet sniffing, and/or the like. There are various examples of how an EBR device may demonstrate content awareness in operation.

The sensor discovery engine (e.g., through data discovery) may identify producers and/or data based on an identity of a producer and/or contents of the data provided by the producer. This functionality of the EBR core 102 (e.g., the sensor discovery engine) may allow only data that a consumer is seeking to be identified and transmitted over a network path, without identifying and transmitting extraneous data. Additionally, the EBR device may enable access to data that fits a domain without needing to know the specifics of the source (e.g., producer). For Example, there are several different formats in which a system may provide data associated with a position (e.g., VMF, Unified Data Library feed (UDL), etc.). Typically, a consumer EBR device would need to know the formats of how the data associated with the position is provided and how to retrieve the data associated with the position based on the source device. With the EBR device, a consumer may request data associated with a position for a given area and a producer EBR device may report the data associated with the position for the given area. The producer EBR device may transmit a position report regardless of the specific source of the data associated with the position transmitted by the producer EBR device.

With the data shaping engine, data may be shaped according to the constraints of current, detected network conditions over a best network path (e.g., a network path having the greatest efficiency at a time of transmitting a message). For example, the data shaping engine may compress data associated with an image attachment of a message. The data shaping engine average data associated with other types of messages across one or more messages before transmitting the one or more messages. How the data may be shaped by the data shaping engine may be defined within the data service on a message by message basis. The data shaping engine may need to detect a data format and/or a data type in order to generate shaping rules for shaping and/or modifying data to be transmitted over a network path. In this way, the data shaping engine may allow an EBR device to transmit data having a high quality (e.g., data presented coherently to consumer devices) even where network conditions worsen and transmission of the full, unshaped and/or unmodified data would be impractical.

The EBR device, for some types of networks and/or applications, may package data into a specific message format such as VMF. The EBR device may package data into a message format where a schema for the data is known by the EBR device. In this way, the EBR device may map data values to a schema of another message format. For example, the EBR device may transmit a position report as a K05.1 message (e.g., including a GPS location) in VMF or the EBR device may transmit an observation report as a K04.1 (e.g., including a size, location, and/or time) message in VMF.

The exemplary EBR core 102 provides a flexible application programming interface (e.g., client API 104) that client applications 108 can use to request data from producers connected into the network architecture. This same client API 104 may provide data that has been requested and delivered to EBR Core 102 on to a requesting consumer client application 108. Additionally, EBR Core 102 can serve as a central manager performing the following exemplary functions:
Managing client applications' requests and advertisements for data, to be described as services below.
Handling mechanisms for discovering data that meets a client application's request.
Determining what network path(s) messages should be exchanged/passed over.
Determining and producing a density of data that can be sent over a given network using data shaping as described herein.

Through the exemplary EBR Core 102 and its use of Utility Functions, data that is available for consumption by producers can be dynamically discovered, requested and delivered to consumers across a network architecture without either the consumer or producer needing to be aware of the mechanisms by which the exchanged data is moving between them.

The data service model architecture of EBR Core 102 is built to allow the advertisement and discovery of data through a service model. Service models group related types of data, defined by object types and attributes, into communities that are described and associated together. Services can represent data that already exists irrespective of any requested need by a consumer. An example of data represented by a service may include a position of a platform. A platform has a position that may be represented as a data point in a service, and this position exists regardless of whether position information is being sought or not by any consumer. Services can also contain descriptions of data that require an action to determine if the data exists. An example of a description of data could include a picture of a specific entity in a given area. The interest for the picture of the specific entity in a given area can exist without knowledge of whether the picture of the specific entity exists or not. Satisfying this data request requires an action of a camera to observe a location until the object being sought is detected, whereby the requested data (e.g., the picture of the specific entity) can then be captured and provided.

Transport proxy 318 may include a microservice application that contains logic (e.g., software instructions) that is unique to monitoring, sending and receiving traffic across a specific (e.g., tactical) network. Each EBR device node may have one or more transport proxies 318 spun up (e.g., instantiated). One or more transport proxies 318 are meant to, for example, be easily and rapidly built for new transports. Transport proxies 318 may be interfaced with EBR core 102 via proxy API 106, and associated gRPC proxy interfaces and/or any desired custom proxy interfaces. Transport proxy 318 may operate in conjunction with optional custom based network monitoring via an associated communication protocol and proxy library. The core EBR utility library may, for example, be populated from transport proxies 318 via transport interfaces.

Transport proxies 318 are designed to work with various types of networks. Generally, transport proxy 318 may determine what protocol to implement for a network. Alternatively, transport proxy 318 may have protocols predetermined based on a type of a network. For example, transport proxy 318 may construct messages in a variable message format (VMF) where an EBR device is transmitting a message across a network such as a network implementing Byzantine fault tolerance (BFT). Other transport protocols may or may not have a requirement for a message format.

When transmitting data and/or messages across a network having a type of, for example, Tactical Scalable Mobile Ad-Hoc Network (TSM™), a multicast communication may be used since messages are broadcast to multiple client devices. The use of the multicast communication may enable greater opportunistic discovery. However, networks such as mobile user objective system (MUOS) point to network or commercial cellular networks do not support multicast communication and therefore may require use of a unicast communication. Additionally, some transport protocols are more suited for sending images and/or larger files across a network path rather than smaller messages. For example, transport proxy 318 may determine which transport protocol of two transport protocols which are supported by transport proxy 318 may be used to transmit a message based on the contents and/or size of the message. Transport proxy 318 may include a suite of protocols and messaging formats that may be included in a definition of transport proxy 318 that may facilitate the use of new transport protocols when required by system and/or network parameters.

The EBR device may leverage CDS systems that are deployed. For example, EBR core 102 may use transport proxy 318 including a CDO proxy that may determine whether data being provided to a CDS system conforms to rules required for the CDS system. A CDO proxy of transport proxy 318 may package messages and/or data into an extensible markup language (XML) format (e.g., one of the accepted formats). EBR core 102 or another component (e.g., transport proxy 318) may perform obfuscation and/or filtering of the data associated with a message transmitted by the EBR device through the CDO proxy of transport proxy 318. The CDO proxy may perform filtering and/or clearing of the data associated with the message on a field-by-field basis based on filtering of additional XML schema that may need to be performed. The specifics of what fields would be filtered for high and/or low messages may be determined by transport proxy 318 based on a CDS policy and rules from an accreditation organization.

### Management Web GUI

The Management Web GUI can, for example, be a microservice web dashboard built in React and Node. In exemplary embodiments, the Management GUI is not required for EBR to run. The Management Web GUI provides easy and intuitive pages to initial install and configure an EBR instance, modify runtime settings live such as data shaping functions, and see live statuses of the containers and the network of EBR nodes.

### Database Service

The Database Service can, for example, be a microservice that allows EBR to communicate with the platform's database. This layer of abstraction allows easier cross platform support and different databases. The database service can include functions for working with general EBR tables such as clients, nodes, and taskings, as well with any data service-specific tables. The data service-specific tables can be initialized and interacted with through extending an abstract class provided by the EBR SDK (Software Development Kit) such as the Centera SDK. An exemplary database service can be associated with a relational/NoSQL database.

### Model Nexus

Model Nexus 120 can, for example, be a microservice that allows edge inference and management of machine learning models. An exemplary Model Nexus 120 is built around an open-source inference engine Tensorflow Serving which is a part of the Tensorflow Extended (TFX) architecture. Model Nexus 120 supports serving and unserving of models, returning inference on EBR data, and using custom pre and post processing functions.

Model Nexus 120 has also implemented a Data Drift Service utilizing the TFX Tensorflow Data Validation library. The library detects schema drift by comparing a schema of training data using a TFX component called SchemaGen and a schema of serving data to check for data error/anomalies. It also detects data skew/drift by comparing statistics of the training data using a TFX component called StatisticsGen and the statistics of the serving data. Data drift is an optional service for data requests and therefore the Data Drift Service is only initiated when, for example, requested as part of an original EBR tasking or local client interfacing directly with TFX.

Data drift service is asynchronous with Model serving service and can be turned off if not desired. Data drift is a trigger for capturing and retaining training to be used for anomaly and model retraining. The detection of data drift and anomalous data capture results in a delivery of captured data if network conditions permit, otherwise a notification of these alerts and the collected data is sent to requesting consumers.

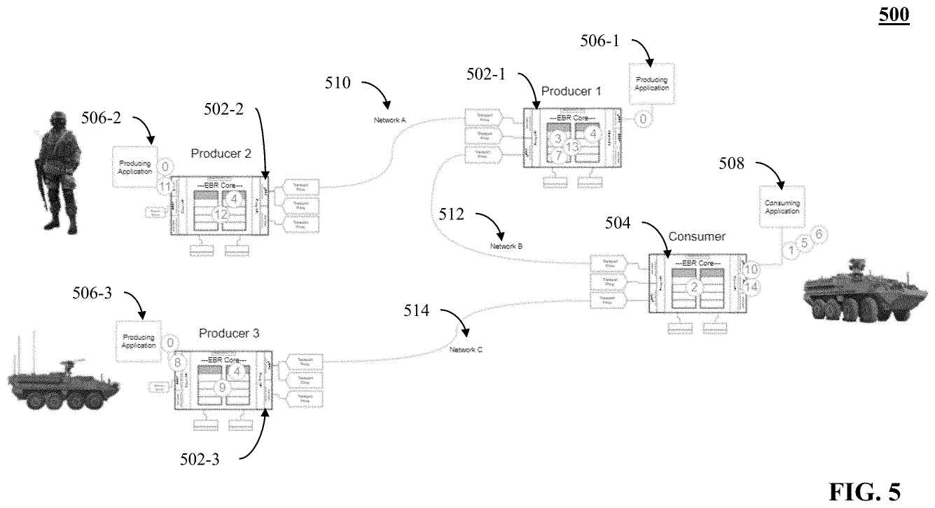

Referring to FIG. 5, shown is an exemplary data flow behavior of an exemplary service model based EBR device within an exemplary EBR network 500 as disclosed herein as it connects data consumers and providers across a multi-transport network architecture. FIG. 5 illustrates an exemplary data flow with reference to functional steps “0)” to “14)” as follows:

0) Three potential producer EBR devices 502 may each be executing a producing application 506 and each producing application 506 may have registered with the producer EBR device 502 node via client API 104 to detail data services each producing application 506 can provide.

1) “Consumer” EBR processing device 504 may request a type of data (e.g., “consumer data”) from EBR client API 104.

2) Consumer EBR device 504 may issue a discovery request for consumer data across multiple networks (e.g., network 510, network 512, network 514) using a mechanism specific to each network where the request is being transmitted over.

3) Producer EBR device 502-1 may disseminates data to network 510 in response to receiving the discovery request received on network 512 from consumer EBR device 504, via producer EBR device 502-1 using a transport mechanism determined by transport proxy 124 appropriate for network 510.

4) Producer data search results may be returned to the requesting consumer EBR device 504 device node from all available producer EBR devices 502 having such data that satisfies the request criteria (e.g., producer EBR devices 502-2, producer EBR device 502-3).

5) Consumer EBR device 504 node (e.g., via the sensor discovery engine) may generate and provide a list of available producer EBR devices 502 that may satisfy the discovery request transmitted from consumer EBR device 504.

6) Consumer EBR device 504 may request data from producer EBR device 502-2 and/or producer EBR device 502-3.

7) The request may be passed (e.g., transmitted) from network 512 to network 510 through producer EBR device 502-1.

8) Producer EBR device 502-3 may include processor based producer application 506-3. Producer application 506-3 may be tasked to provide the requested data to consumer EBR device 504 via network 514 and producer application 506-3 may provide all available data via producer EBR device 502-3 for delivery to consumer EBR device 504.

9) Producer EBR device 502-3 may include an EBR device core (e.g., EBR core 102) that may be aware of network conditions between producer EBR device 502-3 and the requesting consumer EBR device 504. The EBR device core may determine that producer EBR device 502-3 can provide all available data to consumer EBR device 504 over network 514 using mechanisms most appropriate for network 514.

10) An EBR device core of consumer EBR device 504 may receive the data transmitted from producer EBR device 502-3 and consumer EBR device 504 may provide the data to the requesting consumer application 508 of consumer EBR device 504.

11) Producer application 506-2 may be tasked to provide the requested data, and producer application 506-2 may provide all available data within producer EBR device 502-2 for delivery to consumer EBR device 504.

12) An EBR device core (e.g., EBR core 102) of producer EBR device 502-2 may be aware of conditions between itself and consumer EBR device 504, and producer EBR device 502-2 may perform data shaping to shape data using summarization rules. For example, summarization rules can include, without limitation, providing only top-level details or critical attributes of data, dropping attachments and providing only metadata, averaging values or counts for data that exists with multiple instances such as detection reports, and/or using content extraction or object recognition to describe the content of voluminous data types as images and video. This shaped data may be sent to producer EBR device 502-1 using mechanisms most appropriate for network 510.

13) Producer EBR device 502-1 may receive the requested data and producer EBR device 502-1 may pass (e.g., transmit) the data and/or content from producer EBR device 502-2 to the requesting consumer EBR device 504 using mechanisms most appropriate for network 512.

14) The EBR device core (e.g., EBR core 102) of consumer EBR device 504 may receive the data from producer EBR device 502-2 and consumer EBR device 504 may provide the data to the requesting consumer application 508 of consumer EBR device 504.

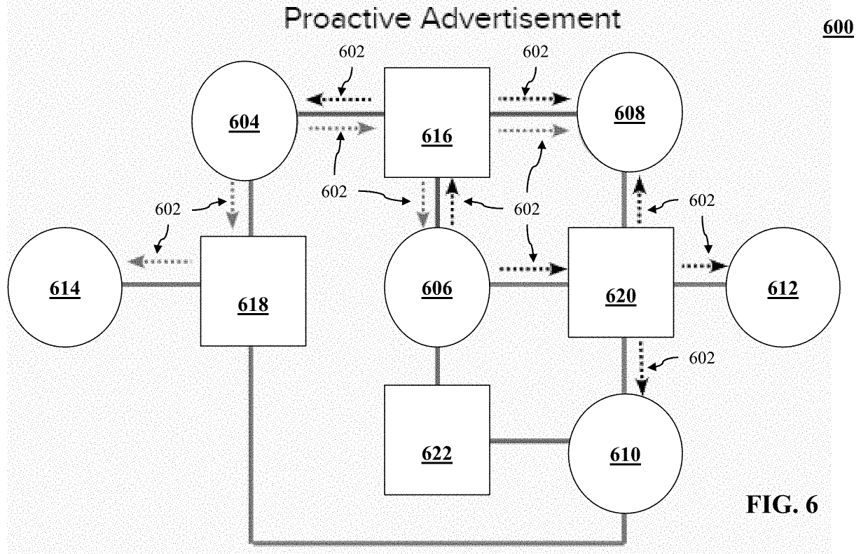

Referring to FIG. 6, shown is employment of proactive message routing of a service model approach within an exemplary EBR network 600 in accordance with exemplary embodiments. Proactive advertisement messages may be, for example, sent on a new client registration (e.g., an EBR device that has registered with the EBR network) and at a periodic interval defined by the data service. The proactive advertisement messages are meant to proactively inform other nodes (e.g., other EBR devices) in the topology about clients, services, routes, etc. without flooding the EBR network. Proactive advertisement messages are broadcasted out from the source node over transports that support them with a TTL of 1.

In FIG. 6, proactive advertisement messages 602 originating from node 604 and node 606 are shown being sent out. Network 616 (with direct connections to node 604, node 608, and node 606) represents a high capability network that supports unicast and multicast (e.g., Wi-Fi). Both proactive advertisement messages 602 are routed to all nodes in network 616. Network 618 (with direct connections to node 604, node 614, and node 610) represents a high capability network that does not support multicast (e.g., LTE®). In the case of network 618, proactive advertisement message 602 may be sent to a NOC (Network Operations Center) of network 618 where all other nodes on network 618 know to access to retrieve and/or view proactive advertisement message 602. Network 620 (with direct connections to node 606, node 608, node 610, and node 612) is a mid-capability network that supports multicast and therefore proactive advertisement message 602 is sent to all nodes in network 620. Network 622 (with direct connections to node 606 and node 610) is a low capability network and therefore proactive advertisement message 602 is not sent over this network.

As already described, an EBR device as disclosed may be configured with any combination of one or more processors, attendant local and/or remote memory, and functional software modules, each processor being configured to execute software functionality as stored in local or remote memory to perform the operational features as described herein. A hardware processor, as used herein, can be a special purpose or a general purpose processor device. The hardware processor device can be connected to a communications infrastructure, such as a bus, message queue, network, multi-core message-passing scheme, etc. An exemplary computing device, as used herein, can also include a memory (e.g., random access memory, read-only memory, etc.), and can also include one or more additional memories. The memory and the one or more additional memories can be read from and/or written to in a well-known manner. In exemplary embodiments, the memory and one or more additional memories can be non-transitory computer readable recording media.

Any of the processors disclosed herein can be part of or in communication with a machine (e.g., a computer device such as an EBR device, a logic device, a circuit, an operating module (hardware, software, and/or firmware), etc.). The processor can be hardware (e.g., processor, integrated circuit, central processing unit, microprocessor, core processor, computer device, etc.), firmware, software, etc. configured to perform operations by execution of instructions embodied in computer program code, algorithms, program logic, control, logic, data processing program logic, artificial intelligence programming, machine learning programming, artificial neural network programming, automated reasoning programming, etc. The processor can receive, process, and/or store data related to sensors and/or network communications (e.g., over an EBR network), for example.

Any of the processors disclosed herein can be a scalable processor, a parallelizable processor, a multi-thread processing processor, etc. The processor can be a computer in which the processing power is selected as a function of anticipated network traffic (e.g. data flow). The processor can include any integrated circuit or other electronic device (or collection of devices) capable of performing an operation on at least one instruction, which can include a Reduced Instruction Set Core (RISC) processor, a CISC microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor may be implemented solely as software or firmware associated with the processor.

The processor can include one or more processing or operating modules. A processing or operating module can be a software or firmware operating module configured to implement any of the functions disclosed herein. The processing or operating module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. Any of the memory discussed herein can be computer readable memory configured to store data. The memory can include a volatile or non-volatile, transitory or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

Any of the processors can be in communication with other processors of other devices (e.g., a computer device such as an EBR device, a computer system, a laptop computer, a desktop computer, etc.). For instance, the processor of EBR core 102 of an EBR device (e.g., a consumer EBR device) can be in communication with the processor of another EBR device (e.g., a producer EBR device), etc. Any of the processors can have transceivers or other communication devices/circuitry to facilitate transmission and reception of wireless signals. Any of the processors can include an API as a software intermediary that allows two or more applications to talk to each other. Use of an API can allow software of the processor of EBR device configuration 100 to communicate with software of the processor of the other device(s) (e.g., other EBR devices in an EBR network).

The memory can be a non-transitory computer-readable medium. The term “computer-readable medium” (or “machine-readable medium”) as used herein is an extensible term that refers to any medium or any memory, that participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. Suitable configurations and storage types will be apparent to persons having skill in the relevant art.

The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, etc. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

As already described, optimal utilization of a varied, growing number of transports employed across multiple networks in use at any given time, currently relies on an underlying data fabric being aware of how to move data most efficiently across a given transport. This can be especially critical when considering lower tactical echelons that are constrained and can sometimes only provide kilobit per second of capacities. Known systems employ transport-specific mechanisms with each transport being used with maximum efficiency. As new transport technologies are adopted, their efficient use involves rapidly incorporating them without causing a cascading effect on all applications and transports already in use. The approach of being transport agnostic outward to applications, but heavily transport aware internally, enables a ready incorporation of new network types to achieve transport optimizations without perturbing existing applications that already leverage the data framework.

Known data fabric technology localizes aspects of the system that need to be transport specific, while still leveraging the most efficient mechanisms to deliver traffic over them. Known EBR solutions pass data using transport proxy microservices. These proxies serve as a transport specific component that encodes data in any optimal format or uses a specific discovery mechanism or protocol based on the specific transport's design. User data moving through known EBR is placed into various formats (e.g., Concise Binary Object Representation or Variable Message Format (VMF)).

Additionally, each transport proxy employs protocols and a mechanism best suited for the transport technology. This, for example, determines when multicast, UDP, or TCP network protocols are used; and/or use of session protocols as Constrained Application Protocol (CoAP), TCP sockets, or MIL-STD-2045-47001.

In an EBR based system, proxies listen for all incoming requests from actual transport interfaces, and the proxies are responsible for implementing messaging or mechanisms specific to each transport including service and/or sensor discovery and protocol manipulation on all outbound traffic. Known software design separates data discovery and management functions from the transport handling mechanisms so as to include a future evolution of the tactical network into the foundation of the data fabric.

In today's multi-transport tactical network architectures, access to data requires extensive pre-configuration and is not dynamically resilient to the changes in network conditions or topologies. Furthermore, efficient use of networks either requires applications to be aware of the network they are operating on or a user needs to take action to ensure applications can operate on the networks currently being used. This results in an inability to scale application development, a hesitancy to deploy new networks since it will require all applications to be compatible with them, or user attention to reconfigure applications to work effectively and persist the flow of data.

Where the present disclosure is implemented using software, the software can be stored in a computer program product or non-transitory computer readable medium and loaded into the computing device using a removable storage drive or communications interface. In an exemplary embodiment, any computing device disclosed herein can also include a display interface that outputs display signals to a display unit, e.g., LCD screen, plasma screen, LED screen, DLP screen, CRT screen, etc.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

What is claimed is:

1. An edge based routing device configured for a multi-transport network, the edge based routing device comprising:
an edge based routing core having a processor configured for providing service model based data services and utility functions;
a client application programming interface configured for receiving producer application data and for outputting consumer application data; and
a proxy application programming interface configured for establishing network layer path selection connectivity between producer applications and consumer applications as a function of network conditions and/or capabilities.

2. The edge based routing device according to claim 1, configured as a software instance, wherein:
the edge based routing core is configured as a service model which will produce data requests as a function of consumer processor based services, and determine paths of a network architecture over which the data requests will be transported.

3. The edge based routing device according to claim 1, wherein:
the edge based routing core is configured for a dynamic, heterogeneous tactical network architecture.

4. The edge based routing device according to claim 1, wherein:
the edge based routing core is configured to perform dynamic data discovery based on proactive advertisement messages, and to disseminate data based on data requirements of consumer processor based services, the data being shaped with a desired data density.

5. The edge based routing device according to claim 1, wherein:
the proxy application programming interface is configured to provide transport mechanism agnostic messaging, which will support transport proactive advertisement messages.

6. The edge based routing device according to claim 1, wherein:
the edge based routing core is configured to access data of producer processors using data requests and/or subscriptions.

7. The edge based routing device according to claim 1, wherein:
the edge based routing core is configured to perform dynamic data discovery and to access transport and network status information when an alert is observed and/or a sensor reports an alert with respect to request parameters.

8. The edge based routing device according to claim 1, wherein:
the edge based routing core is configured to perform dynamic data discovery, in combination with an edge based routing device of a consumer processor and edge based routing device of a producer application.

9. The edge based routing device according to claim 1, wherein:
the edge based routing core is configured to assemble situational awareness information received from producer applications for a specified area in a tactical network environment.

10. A method for managing communication across multiple networks, between a producer application of a network and a consumer application of a network, using a network edge based routing device, the method comprising:
receiving a service model based consumer application request for consumer data at an edge based routing device;
executing discovery for consumer data across multiple networks via an edge based routing device;
receiving discovered consumer data at an edge based routing device from producer applications via multiple networks and a selected transport mechanism suited to a specified one of the multiple networks;
providing a list of available data producer applications via an edge based routing device to a consumer application associated with the service model based consumer application request;
passing the service model based consumer application request across multiple networks to a producer application; and
receiving producer application data at an edge based routing device for transport to the consumer application.

11. The method according to claim 10, wherein an edge based routing device is configured as a service model, further comprising:
producing data requests as a function of consumer processor based services via an edge based routing device; and
determining paths of a network architecture over which the data requests will be transported via an edge based routing device.

12. The method according to claim 10, wherein an edge based routing device is configured for a dynamic, heterogeneous tactical network architecture.

13. The method according to claim 10 further comprising:
performing dynamic data discovery based on proactive advertisement messages via an edge based routing device; and
disseminating data based on data requirements of consumer processor based services, the data being shaped with a desired data density via an edge based routing device.

14. The method according to claim 10, wherein:
a proxy application programming interface is configured to provide transport mechanism agnostic messaging which will support transport proactive advertisement messages.

15. The method according to claim 10, further comprising:
accessing data of producer processors using data requests and/or subscriptions via an edge based routing device.

16. The method according to claim 10, further comprising:
performing dynamic data discovery via an edge based routing device; and
accessing transport and network status information when an alert is observed and/or a sensor reports an alert with respect to request parameters via an edge based routing device.

17. The method according to claim 10, further comprising:
performing dynamic data discovery, in combination with an edge based routing device of a consumer processor and an edge based routing device of a producer application.

18. The method according to claim 10, further comprising:
assembling situational awareness information received from producer applications for a specified area in a tactical network environment via an edge based routing device.
